(19) United States
(12) Patent Application Publication
(10) Pub. No.: US 2009/0081508 A1
(43) Pub. Date: Mar. 26, 2009

(54) FUEL CELL

(76) Inventor: Donald Ashley, Millersville, MD (US)

Correspondence Address: MICHAEL RIES, 318 PARKER PLACE, OSWEGO, IL, 60543, US

(21) Appl. No.: 12/237,376

(22) Filed: Sep. 24, 2008

Related U.S. Application Data
(60) Provisional application No. 60/974,847, filed on Sep. 25, 2007.

(51) Int. Cl. H01M 8/02

(52) U.S. Cl. 429/26

(57) ABSTRACT

Disclosed is a fuel cell system to raise energy saving efficiencies. A heat exchanger with dual fluid is used in place of a cooling fan to capture waste heat from a normal fuel cell stack. The present invention combines a sterling engine with a fuel cell stack. Fluid controls are made to maximize efficiencies of waste heat from normal fuel cell stacks with the efficiencies of geo thermal fluids in the production of electricity.

This application claims priority to U.S. Provisional Application 60974847 filed 25-SEP-2007, the entire disclosure of which is incorporated by reference.

### TECHNICAL FIELD AND BACKGROUND

The present invention relates to a fuel cell system. More specifically, the present invention combines a fuel cell with a geo thermal/sterling engine to reduce the energy costs to a user.

The present invention is a fuel cell system to raise energy saving efficiencies. A heat exchanger with dual fluid is used in place of a cooling fan to capture waste heat from a normal hydrogen fuel stack. The present invention combines a sterling engine with a fuel cell stack. Fluid controls are made to maximize efficiencies of waste heat from fuel cell stacks. The present invention combines the geothermal electric generation of a sterling engine with hydrogen fuel cell sized to fit the electrical demand of an end user. The user may be residential, commercial or industrial. The present invention heats water from the excess BTU thermal waste of the fuel cell that decreases the overall cost of energy to the end user.

### BRIEF DESCRIPTION OF THE DRAWINGS

The objects, features, and advantages of the present invention will be apparent from the following detailed description of the preferred embodiment of the invention with references to the following drawings.

FIG. 1 is a drawing of a top view of a fuel cell of one embodiment of the present invention.

FIG. 2 is a drawing of an end view of a fuel cell of one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

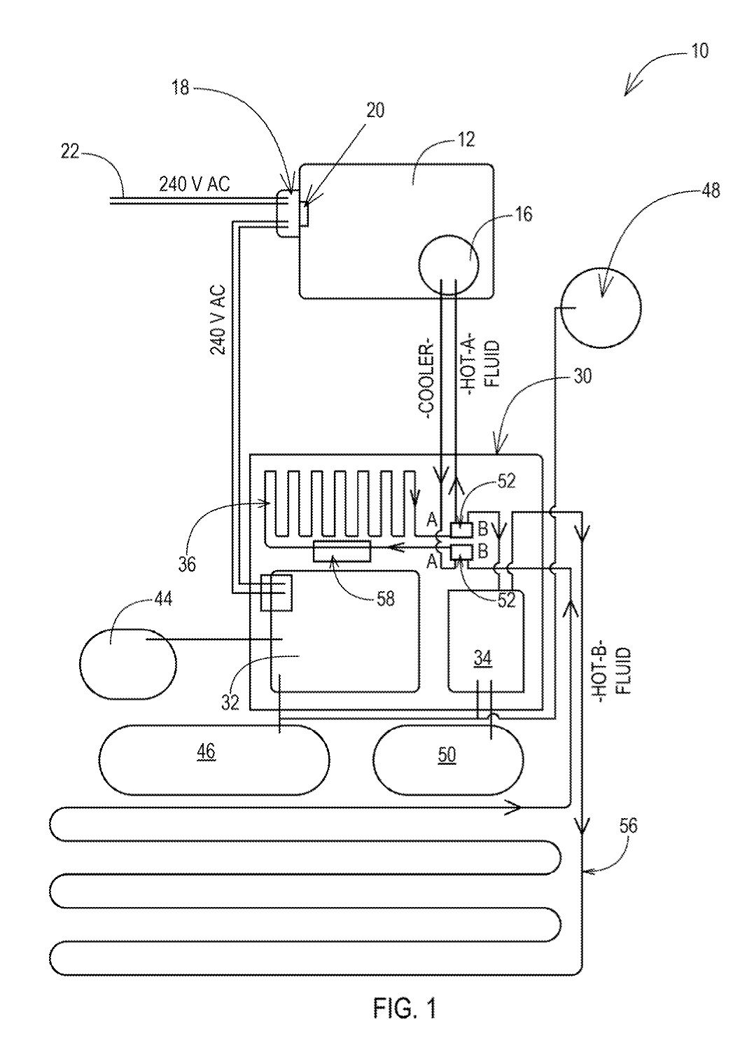

Referring to FIG. 1, as in one embodiment is a top view of a fuel cell 10 system. Shown are a dwelling 12 that may be residential, commercial or industrial with hot water tank 16, automatic electric transfer switch 18 with a dwelling disconnect 20. The automatic electric transfer switch 18 will have a grid supply line 22 that can return excess capacity to a utility grid. Grid supply line 22 is typically 240 V. AC. In metal enclosure 30 is hydrogen fuel cell stack 32, sterling engine 34, and fuel cell heat exchanger 36. Fuel cell heat exchanger 36 is for waste heat from hydrogen fuel cell stack 32. A DC-AC inverter wave form conditioner 40 is connects the hydrogen fuel cell stack 32 to the automatic electric transfer switch 18 and may be 240 V. AC. Distilled water 44 is excess by product of hydrogen fuel cell stack 32. Ninety nine percent pure hydrogen gas 46 is supplied to the hydrogen fuel cell stack 32 to start the fuel cell. Ninety nine percent pure hydrogen gas 46 may come from a hydrogen cylinder bottle 48. Cutting touch oxygen 50 is an excess by product. Shown are electric solenoids 52. Electric solenoids 52 have an open position A and a closed position B to transfer the fluid. Metallic lines 56 are buried on a customer's lot with tracer tape for future reference. Shown is in line pump return line 58.

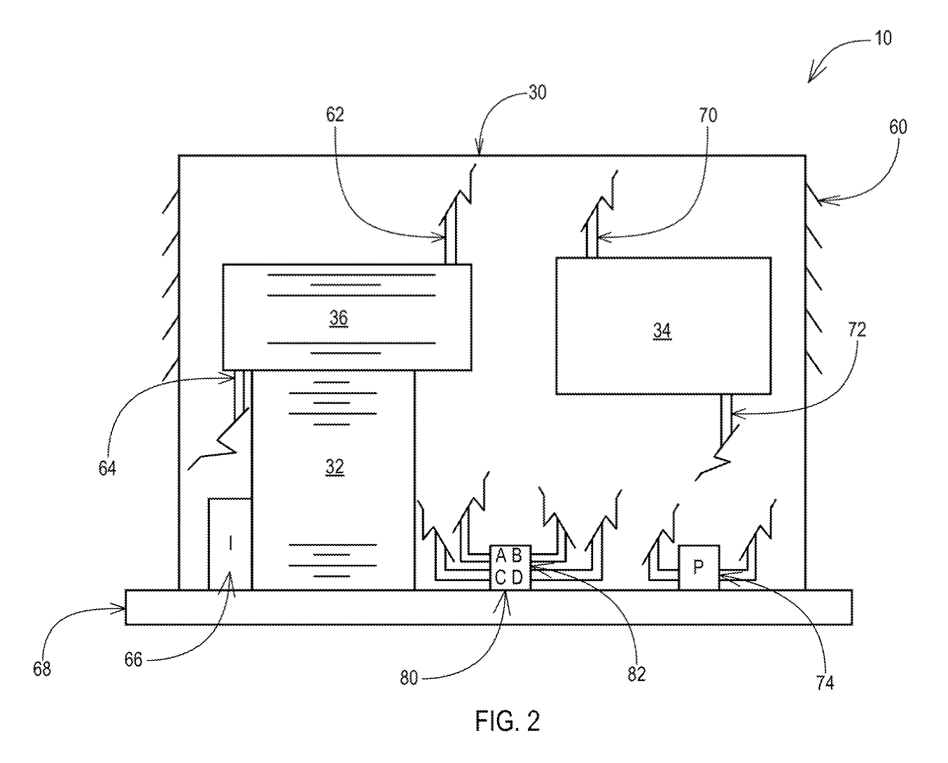

In FIG. 2, as in one embodiment is a side view of the fuel cell 10. Shown is metal enclosure 30 with vents 60 for excess heat to escape. Fuel cell heat exchanger 36 has duel fluid cooling tubes out 62 and duel fluid cooling tubes in 64. Fuel cell heat exchanger 36 is on top of the hydrogen fuel cell stack 32 with DC AC inverter 66 connected to the hydrogen fuel cell stack 32, the AC DC inverter 66 may be DC to 120 to 240 V AC. The entire fuel cell 10 is connected to a concrete base pad 68. Shown is hot cooling tube in 70 from the fuel cell heat exchanger 36 connected to the sterling engine 34. Cold cooling tube out 72 is shown connected to sterling engine 34 and going to a geo thermal tube bed or wells. A circulate fluid pump 74 is shown. A fluid valve 80 with dual fluid control valves solenoid electrical controls 82 are shown.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A device comprising:
a heat exchanger with dual fluid controls;
a sterling engine connected to the heat exchanger; and
a fuel cell stack below the heart exchanger.

2. The device of claim 1 wherein ninety nine percent pure hydrogen is supplied to the fuel cell stack.

3. The device of claim 1 wherein cutting torch grade oxygen is an excess by product of the fuel cell stack.

4. The device of claim 1 wherein distilled water is an excess by product of the fuel cell stack.

5. The device of claim 1 wherein a fluid valve heats a hot water heater tank as first priority.

6. The device of claim 1 wherein the dual fluid controls are electrical solenoids thermostatically controlled chosen for which priority by a desired result of a end user.
